(19) United States
(12) Patent Application Publication
(10) Pub. No.: US 2018/0117948 A1
(43) Pub. Date: May 3, 2018

(54) AN APERIODIC MOIRE SECURITY ELEMENT AND METHOD FOR PRODUCTION THEREOF

(71) Applicant: CCL SECURE PTY LTD, Craigieburn, Victoria (AU)

(72) Inventor: Gary Fairless Power, Craigieburn, Victoria (AU)

(73) Assignee: CCL SECURE PTY LTD, Craigieburn, Victoria (AU)

(21) Appl. No.: 15/561,866

(22) PCT Filed: Mar. 24, 2016
(86) PCT No.: PCT/AU2016/050215

§ 371 Date: Sep. 26, 2017

(30) Foreign Application Priority Data
Mar. 26, 2015 (AU) 2015100385
Mar. 26, 2015 (AU) 2015901099

(51) Int. Cl. B42D 25/342; B42D 25/324; B42D 25/328; B42D 25/373; B42D 25/425; B42D 25/378; B41M 3/14; B41M 1/24

(52) U.S. Cl. CPC B42D 25/342; B42D 25/324; B42D 25/328; B42D 25/373; B42D 25/29; B42D 25/378; B41M 3/148; B41M 1/24; B42D 25/425

(57) ABSTRACT

A moiré magnification device for authenticating security articles, the moiré magnification device comprising: an array of micro focusing elements; and an array of micro images; wherein the array of micro focusing elements and the array of micro images are correspondingly aperiodic such that the micro focusing elements generate moiré magnifications of the micro image when viewing the device at predetermined viewing angles. A device such as this raises the complexity and difficulty of the task facing would-be counterfeiters. The use of an aperiodic micro focusing element array and micro image array is not immediately apparent, as the moiré magnifications observed by the viewer appear the same as that of a regular device with periodic arrays. In this way, the aperiodic aspect of the design remains covert until the moiré device is more closely and deliberately analysed.

### FIELD OF THE INVENTION

The present invention relates to optical security elements and their methods of production. In particular, the invention is concerned with an aperiodic moiré magnification device for authenticating security articles. For convenience, the invention will be described with particular reference to the authentication of banknotes and the like against counterfeiting. However, it will be appreciated that the invention extends to the verification of many other types of value documents and security articles.

### BACKGROUND OF THE INVENTION

Security features have traditionally been applied to banknotes and other security documents to frustrate the efforts of would-be counterfeiters. Printed features such as guilloches or fine line patterns are now commonplace and relatively easy for counterfeiters to reproduce. Diffractive optically variable devices (DOVDs) such as holograms and diffractive gratings are often applied to banknotes as the physical microstructure is more difficult to replicate. Unfortunately, more sophisticated counterfeiters have some success with copying the diffractive microstructures using contact copying techniques.

Some alternative security devices make use of micro lenses or lenticular lenses to view an array of graphic elements. The combined visual effect of the lenses and underlying graphic elements can produce magnifications of the graphic elements. For example, it is known to provide a lenticular lens comprising an array of semi-cylindrical lenses for viewing underlying graphic elements in the form of interlaced strips of different images. As the viewing angle changes, different strips of respective images come into view such that an animation effect is generated in which successive frames correspond to successive strips in the series.

Another security device is disclosed in U.S. Pat. No. 5,712,731 to Drinkwater at al. Graphic elements in the form of a two-dimensional array of identical micro images are printed on a substrate. The micro image array is viewed through a corresponding two-dimensional array of cylindrical micro lenses. A slight mismatch between the pitch or rotational alignment of the micro image array and the micro lens array produces moiré fringes in the form of one or more magnified versions of the underlying micro images. Within the security document industry, these optical security devices are referred to as ‘moiré magnifiers’.

Moiré magnifiers can be used to generate optical impressions of the micro images that appear to float above, below or in the plane of the device as the viewing angle changes (see, for example, the Unison™ security devices described in AU 2010226869 to Visual Physics LLC). The slight mismatch between the period of the lens array and that of the micro image array is often provided by a small rotation or skew of the lens array relative to the micro image array. Magnifications of the micro images are generated because adjacent micro lenses focus on, and magnify, slightly different portions of adjacent micro images. One micro lens ‘sees’ a patch of the corresponding micro image in the focal plane of the lens array. The neighbouring micro lens in the array sees a slightly different patch (possibly overlapping with first patch) of the adjacent micro image. These patches combine in the eye of the viewer to generate one or more moiré magnifications of the micro images.

As the viewing angle changes, the patch of each micro image seen by the corresponding lens also moves such that the magnified image seems to move (in linear motion and/or rotation) relative to the substrate. Parallax effects from binocular viewing of the lens array cause the magnified image to appear in a plane above, beneath or in the plane of the document substrate. A detailed explanation of these aspects of moiré magnification is set out in WO 2005/106601 to De La Rue International Ltd.

Fabricating the micro lens array and the micro image array requires precision equipment not readily available to the typical counterfeiter. Furthermore, the large variations in moiré magnification with very small changes in the pitch mismatch of the two arrays demand exceptionally accurate positioning of the lens array relative to the micro image array. Despite these hurdles, the expertise and capabilities of sophisticated counterfeiters is ever improving. Hence there is an ongoing need to raise the counterfeit resistance of security devices for documents and other articles of value.

### SUMMARY OF THE INVENTION

In one aspect, the present invention provides a moiré magnification device for authenticating security articles, the moiré magnification device comprising:
an array of micro focusing elements; and
an array of micro images; wherein
the array of micro focusing elements and the array of micro images are correspondingly aperiodic such that the micro focusing elements generate moiré magnifications of the micro image when viewing the device at predetermined viewing angles.

In another aspect, the present invention provides a method of producing a moiré device for authenticating security articles, the method comprising the steps of:
forming an aperiodic array of micro focusing elements;
forming an aperiodic array of micro images positioned relative to corresponding micro focusing elements within the aperiodic array of micro focusing elements; such that,
the array of micro focusing elements generate moiré magnifications when the device is viewed from predetermined angles.

The moiré magnification device of the present invention substantially raises the complexity and difficulty of the task facing would-be counterfeiters. The use of an aperiodic micro focusing element array and micro image array is not immediately apparent, as the moiré magnifications observed by the viewer appear the same as that of a regular device with periodic arrays. In this way, the aperiodic aspect of the design remains covert until the moiré device is more closely and deliberately analysed. The ordinary worker in this field will readily understand that the micro focusing elements can take different forms, such as micro lenses, Fresnel lenses or concave micro mirrors.

In an aperiodic micro lens array, the individual lenses may be randomly positioned but generally close-packed. Each micro image in the corresponding micro image array is displaced, and possibly distorted relative to other micro images, such that each part of the micro image seen by each micro lens for a particular viewing angle (or range of viewing angles), will correctly combine into the desired magnified image. The equipment and micro-processing capability required to correctly generate the micro lenses and micro images with the necessary displacements and distortions is a significant disincentive to those seeking to replicate the security device.

In some preferred embodiments, the moiré magnifications generated by the array of micro focusing elements and the micro image array are equivalent to moiré magnifications generated by a periodic micro focusing element array and the corresponding periodic micro image array.

Preferably, the device further comprises a substrate, such as a transparent polymer, and the aperiodic array of micro focusing elements is embossed on one side of the substrate while the aperiodic array of micro images is embossed on the opposing side of the substrate.

Optionally, the micro focusing element array and the micro image array are formed on the same side of the substrate, the micro image array comprising individual image elements in registration with one of the micro focusing elements respectively.

In particular embodiments, the micro focusing elements are concave micro mirrors and the individual image elements are formed at the surface of the corresponding micro mirrors. Preferably, the individual image elements are embossed into the surface of the corresponding micro mirror. In a further preferred form, the concave surface of the micro mirrors is coated, preferably with a metallic coating.

In some embodiments, the image elements are coated for optical contrast with the concave surface of the micro mirrors.

In specific embodiments, the image elements are embossed as diffractive gratings, holographic structures or moth-eye structures in the surface of the concave micro mirrors.

In particular embodiments, the micro image array comprises a first set of micro images and a second set of micro images, the first set of micro images and the second set of micro images being aperiodic in accordance with the aperiodicity of the micro focusing element array such that the moiré magnifications of the first set of micro images appear to be at a different plane to the moiré magnifications of the second set of micro images.

During production of the moiré magnification device, it is preferable to
provide a substrate, and
emboss the micro focusing elements on one side of the substrate while simultaneously embossing the micro images on the other side of the substrate.

Preferably, the micro focusing elements and the micro images are embossed into a radiation curable material applied to the substrate and subsequently or simultaneously cured.

In some embodiments, the array of micro images comprises individual image elements embossed into respective micro focusing elements within the array of micro focusing elements. Preferably the individual image elements and the micro focusing elements are simultaneously embossed on the one side of the substrate.

In some embodiments, the micro focusing elements have different sizes and focal lengths.

In a particularly preferred embodiment, the moiré magnification device is applied to a security article in the form of a banknote.

### Definitions

### Security Document or Token

As used herein the term security documents and tokens includes all types of documents and tokens of value and identification documents including, but not limited to the following: items of currency such as banknotes and coins, credit cards, cheques, passports, identity cards, securities and share certificates, driver's licenses, deeds of title, travel documents such as airline and train tickets, entrance cards and tickets, birth, death and marriage certificates, and academic transcripts.

The invention is particularly, but not exclusively, applicable to security documents or tokens such as banknotes or identification documents such as identity cards or passports formed from a substrate to which one or more layers of printing are applied. The diffraction gratings and optically variable devices described herein may also have application in other products, such as packaging.

### Security Device or Feature

As used herein the term security device or feature includes any one of a large number of security devices, elements or features intended to protect the security document or token from counterfeiting, copying, alteration or tampering. Security devices or features may be provided in or on the substrate of the security document or in or on one or more layers applied to the base substrate, and may take a wide variety of forms, such as security threads embedded in layers of the security document; security inks such as fluorescent, luminescent and phosphorescent inks, metallic inks, iridescent inks, photochromic, thermochromic, hydrochromic or piezochromic inks; printed and embossed features, including relief structures; interference layers; liquid crystal devices; lenses and lenticular structures; optically variable devices (OVDs) such as diffractive devices including diffraction gratings, holograms and diffractive optical elements (DOEs).

### Substrate

As used herein, the term substrate refers to the base material from which the security document or token is formed. The base material may be paper or other fibrous material such as cellulose; a plastic or polymeric material including but not limited to polypropylene (PP), polyethylene (PE), polycarbonate (PC), polyvinyl chloride (PVC), polyethylene terephthalate (PET), biaxially-oriented polypropylene (BOPP); or a composite material of two or more materials, such as a laminate of paper and at least one plastic material, or of two or more polymeric materials.

### Embossable Radiation Curable Ink

The term embossable radiation curable ink used herein refers to any ink, lacquer or other coating which may be applied to the substrate in a printing process, and which can be embossed while soft to form a relief structure and cured by radiation to fix the embossed relief structure. The curing process does not take place before the radiation curable ink is embossed, but it is possible for the curing process to take place either after embossing or at substantially the same time as the embossing step. The radiation curable ink is preferably curable by ultraviolet (UV) radiation. Alternatively, the radiation curable ink may be cured by other forms of radiation, such as electron beams or X-rays.

The radiation curable ink is preferably a transparent or translucent ink formed from a clear resin material. Such a transparent or translucent ink is particularly suitable for printing light-transmissive security elements such as sub-wavelength gratings, transmissive diffractive gratings and lens structures.

In one particularly preferred embodiment, the transparent or translucent ink preferably comprises an acrylic based UV curable clear embossable lacquer or coating.

Such UV curable lacquers can be obtained from various manufacturers, including Kingfisher Ink Limited, product ultraviolet type UVF-203 or similar. Alternatively, the radiation curable embossable coatings may be based on other compounds, eg nitro-cellulose.

The radiation curable inks and lacquers used herein have been found to be particularly suitable for embossing microstructures, including diffractive structures such as diffraction gratings and holograms, and microlenses and lens arrays. However, they may also be embossed with larger relief structures, such as non-diffractive optically variable devices.

The ink is preferably embossed and cured by ultraviolet (UV) radiation at substantially the same time. In a particularly preferred embodiment, the radiation curable ink is applied and embossed at substantially the same time in a Gravure printing process.

Preferably, in order to be suitable for Gravure printing, the radiation curable ink has a viscosity falling substantially in the range from about 20 to about 175 centipoise, and more preferably from about 30 to about 150 centipoise. The viscosity may be determined by measuring the time to drain the lacquer from a Zahn Cup #2. A sample which drains in 20 seconds has a viscosity of 30 centipoise, and a sample which drains in 63 seconds has a viscosity of 150 centipoise.

With some polymeric substrates, it may be necessary to apply an intermediate layer to the substrate before the radiation curable ink is applied to improve the adhesion of the embossed structure formed by the ink to the substrate. The intermediate layer preferably comprises a primer layer, and more preferably the primer layer includes a polyethylene imine. The primer layer may also include a cross-linker, for example a multi-functional isocyanate. Examples of other primers suitable for use in the invention include: hydroxyl terminated polymers; hydroxyl terminated polyester based co-polymers; cross-linked or uncross-linked hydroxylated acrylates; polyurethanes; and UV curing anionic or cationic acrylates. Examples of suitable cross-linkers include: isocyanates; polyaziridines; zirconium complexes; aluminium acetylacetone; melamines; and carbodi-imides.

### BRIEF DESCRIPTION OF THE DRAWINGS

Preferred embodiments of the present invention will now be described by way of example only with reference to the accompanying drawings, in which:

FIG. 1 is a schematic plain view of a prior art moiré magnification device.

FIG. 2 is a schematic section view through a prior art moiré magnification device.

FIG. 3 is a schematic plain view of a moiré magnification device according to the invention.

FIG. 4 is a schematic cross-section of a moiré magnification device according to the invention.

FIG. 5 is a schematic cross-section of a moiré magnification device according to the invention, in which concave micro mirrors are used as focusing elements.

FIG. 6 is a schematic representation of the moiré magnification device applied to a banknote.

FIG. 7 is a schematic cross-section of a moiré magnification device according to the invention for magnification of two different micro image arrays.

### DETAILED DESCRIPTION OF PREFERRED EMBODIMENTS

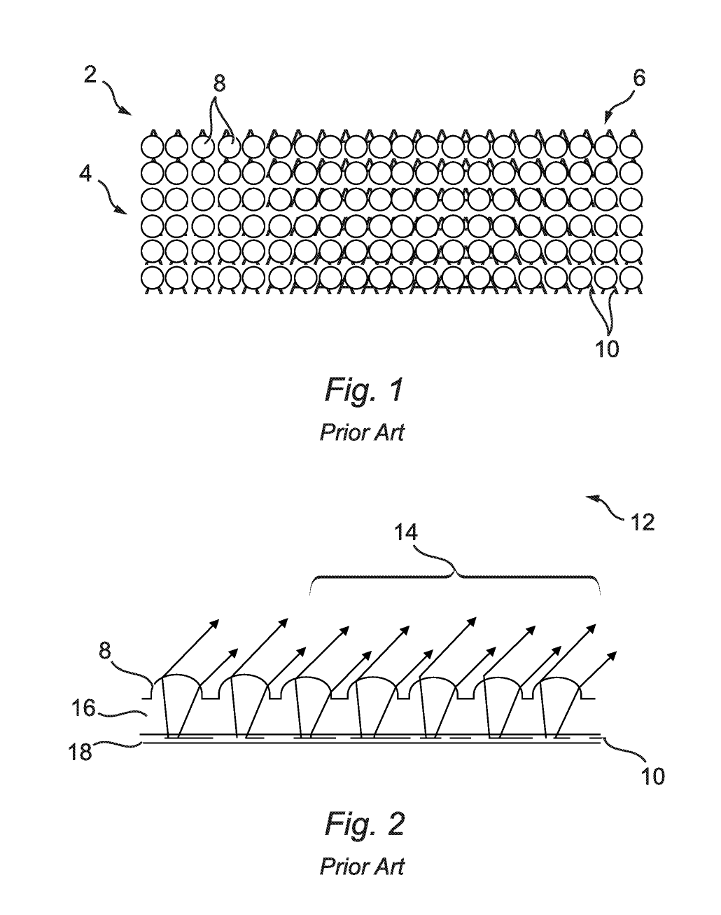

FIGS. 1 and 2 illustrate a basic form of known moiré magnification devices 2. A lens array 4 is positioned on graphic elements in the form of a micro image array 6. The micro lens array 4 and the micro image array 6 are both periodic in that the individual lenses 8 and the individual micro images 10 are at regular spacings within their respective arrays.

As shown in FIG. 1, there is a slight mismatch between the spacing or pitch of the micro lenses 8 and that of the micro images 10. This causes each micro lens 8 to focus on a slightly different part of the underlying micro image compared to its neighbouring micro lenses.

As illustrated in FIG. 2, the individual magnifications from each micro lens 8 are combined in the eye of the viewer 12 to produce one or more moiré magnifications 14 of the micro images 10.

The micro lens layer 16 needs to be precisely positioned relative to the micro image layer 18 to generate the required degree of magnification. Skilled workers in this field will readily understand that very small changes in the pitch mismatch between the micro lenses 8 and the micro images 10 result in very large changes in the degree of magnification. This level of precision is difficult for counterfeiters to achieve and thus moiré magnification devices offer a reasonably effective counterfeit resistance measure. Unfortunately, sophisticated counterfeiters are able to replicate the moiré magnification device such that it generates reasonably similar magnifications of the micro images.

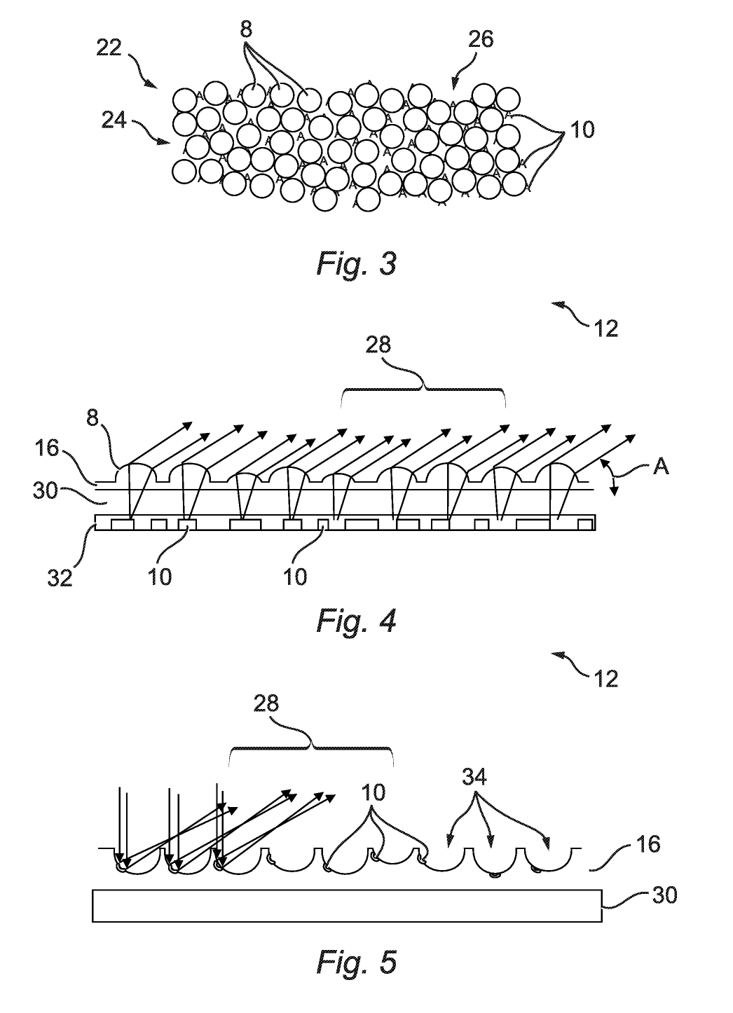

To address this, the moiré magnification device 22 shown in FIG. 3 uses an aperiodic micro focusing element array 24 and a correspondingly aperiodic micro image array 26. The micro focusing elements 8 are randomly positioned but still relatively close packed. Knowing the random positions of each micro focusing element 8, a corresponding position for an underlying micro image can be determined which still generates a moiré magnification when viewed from a particular angle or range of angles. As shown in FIG. 4, the micro focusing elements are micro lenses 8 that each individually magnify an underlying portion or part of different micro images 10 formed in a micro image layer 32. Using the known moiré magnified image 28 to be seen by the eye 12 from viewing angle α, it is possible to determine the precise position and shape of the underlying micro images 10 required to generate the magnified image 28.

Similarly, the micro images 10 can be individually configured and distorted (relative to the micro image that would be used in a periodic moiré magnification device) such that the desired moiré magnification 28 is visible over a range of viewing angles α. To achieve this requires significant computer processing capabilities to accurately determine the configuration of the micro images 10. Similarly, it is necessary to precisely fabricate and position the micro focusing elements 8 relative to the micro images 10. The equipment plant processing capacity needed to accurately generate the desired magnified image 28 is well beyond the typical counterfeiter. Furthermore, the aperiodic nature of the moiré magnification device is not immediately apparent. Its operation will closely mimic that of a normal moiré magnification device and therefore its aperiodic design becomes a covert security feature.

The precise registration between the micro focusing elements and the micro images 10 may be provided by a so-called ‘double soft embossing process’. This process involves embossing a radiation curable epoxy layer deposited on both sides of a substrate. In FIG. 4, the substrate 30 supports a UV curable epoxy layer 16 on one side and a similar UV curable layer 32 on the opposing side. The moiré magnification device us compressed between opposing metal shims with surface relief in the form of a negative of the micro focusing element array 24 and a negative of the micro image array 26. This ensures that each micro focusing element 8 is in precise alignment with its corresponding micro image 10.

Layers 16 and 32 are uncured and soft prior to embossing. The curing process takes place shortly after or substantially at the same time as the embossing step. The radiation curable material is typically curable by ultra-violet (UV) radiation, however other radiation curable materials may be used which are sensitive to X-rays or electron beams.

The radiation curable materials used to form layers 16 and 32 are transparent or translucent and preferably include an acrylic based UV curable clear embossable lacquer or coating. Such UV curable lacquers can be obtained from various manufacturers including Kingfisher Ink Ltd, product Ultra-Violet Type UVF-203 or similar. Alternatively, the radiation curable embossable coatings may be based on other compounds, such as nitrocellulose.

The substrate 30 is typically the base material from which the security document to which the moiré magnification device is applied. The base material is a plastic or polymeric material including but not limited to polypropylene (PP), polyethylene (PE), polycarbonate (PC), polyvinylchloride (PVC), polyethylene terephthalate (PET), biaxially-oriented polypropylene (BOPP), or a composite material of two or more materials.

FIG. 5 shows an embodiment of the moiré magnification device 22 in which the micro focusing elements are in the form of concave micro mirrors 34. Skilled workers in this field will readily understand that a micro image (or part of a micro image) 10 applied to the concave surface of a concave micro mirror 34 can provide a magnification of the micro image 10 equivalent to that of a micro lens focusing on an underlying micro image.

For precise registration between the concave micro mirrors 34 and the micro images 10, the micro mirrors and micro images can be simultaneously embossed into the UV curable material 16. Simultaneously embossing the micro images with micro mirrors requires the metal embossing shim to have a negative surface relief of the micro mirrors overlaid with a negative of the corresponding aperiodic micro images. However this ensures perfect registration (as in relative positioning to achieve the desired magnification) between the aperiodic array of focusing elements 24 and the micro image array 26. The lithographic fabrication of these metal shims (typically from nickel) is an advanced manufacturing technique beyond the reach of most counterfeiters.

The surface of the concave micro mirrors 34 may include a coating such as vapour deposited metal in order to improve reflection of incident light. Furthermore, it will be appreciated that this embodiment does not rely on transmission of light through the substrate 30. Therefore this form of the moiré magnification device can be applied to value documents with opaque substrates 30.

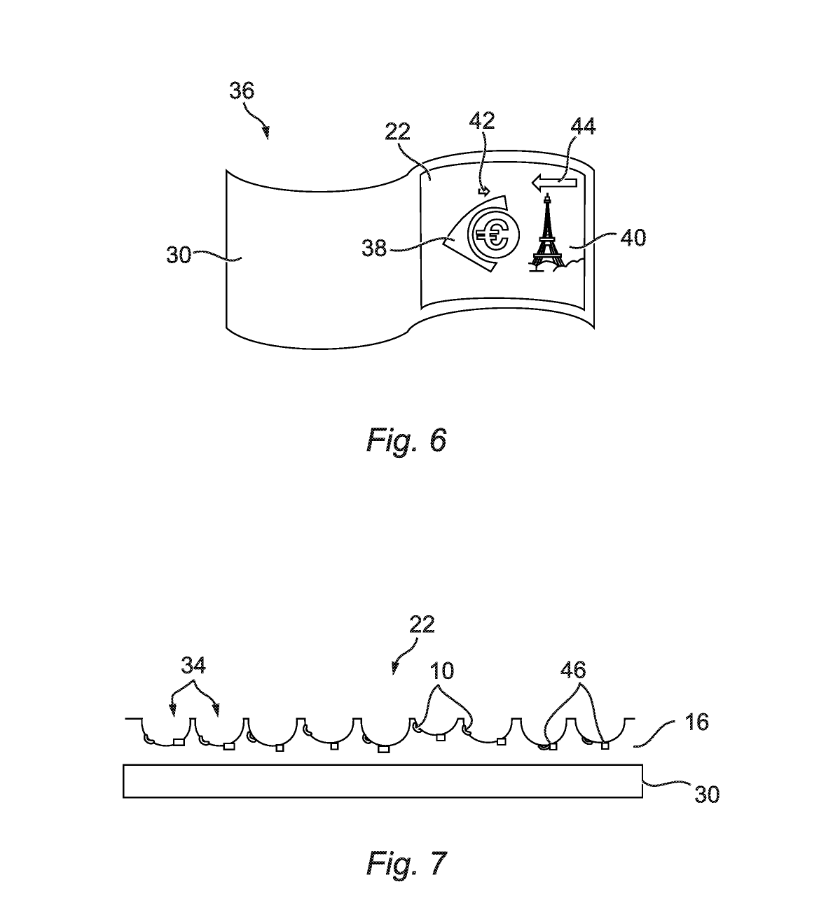

FIGS. 6 and 7 show another form of the moiré magnification device 22 applied to a banknote 36. The micro focusing elements are provided in the form of concave micro mirrors 34 as discussed above in relation to FIG. 5. However the magnification device 22 has two different micro image arrays, the first including micro images 10 and the second including micro images 46. Skilled workers in this field will understand that moiré magnification devices can magnify two different images or different views of the same image which can be used to generate a 3D image or a moving image (see, for example, FIG. 2 of U.S. Pat. No. 5,712,731 to Drinkwater et al, and FIG. 29 of AU 2010226869 to Visual Physics LLC). Furthermore, if the aperiodic positioning of micro elements 10 corresponds to a regular moiré magnification device in which the period mismatch between the micro lenses and micro images is set at a first value, which determines the orthoparallactic movement (OPM) 42 of the first moiré magnification 38 in response to a change in viewing angles. Similarly, the aperiodic positioning of the second micro elements 46 can be such that it is equivalent to a period mismatch of a second value which generates orthoparallactic movement (OPM) 44 of the second moiré magnification 40 which noticeably differs from the OPM 42 of the first magnification 38 in response to the same change in viewing angles.

This added level of complexity not only makes the moiré magnification device 22 more visually distinctive when used, but also compounds the difficulty for counterfeiters. Accordingly, the aperiodic array of micro focusing elements 24 may be embossed with three or more separate arrays of micro images to further heighten the complexity and security of the device. Similarly, the size and focal length of the concave micro mirrors can be varied within the array as yet another level of complexity.

The invention has been described herein by way of example only. Skilled workers in this field will readily recognise any variations or modifications which do not depart from the spirit and scope of the broad inventive concept.

1. A moiré magnification device for authenticating security articles, the moiré magnification device comprising:
an array of micro focusing elements; and
an array of micro images; wherein
the array of micro focusing elements and the array of micro images are correspondingly aperiodic such that the micro focusing elements generate moiré magnifications of the micro image when viewing the device at predetermined viewing angles.

2. A moiré magnification device according to claim 1, wherein the moiré magnifications generated by the array of micro focusing elements and the micro image array are equivalent to moiré magnifications generated by a periodic micro focusing element array and corresponding periodic micro image array.

3. A moiré magnification device according to claim 1, wherein the device further comprises a substrate, such as a transparent polymer, and the aperiodic array of micro focusing elements is embossed on one side of the substrate while the micro images is embossed on the opposing side of the substrate.

4. A moiré magnification device according to claim 1, wherein the device comprises a substrate, such as a transparent polymer, and the micro focusing element array and the micro image array are formed on the same side of the substrate, the micro image array comprising individual image elements in registration with one of the micro focusing elements respectively.

5. A moiré magnification device according to claim 4, wherein the micro focusing elements are concave micro mirrors and the individual image elements are formed at the surface of the corresponding micro mirrors.

6. A moiré magnification device according to claim 5, wherein the individual image elements are embossed into the surface of the corresponding micro mirror.

7. A moiré magnification device according to claim 5, wherein the concave surface of the micro mirrors is coated, preferably with a metallic coating.

8. A moiré magnification device according to claim 5, wherein the image elements are coated for optical contrast with the concave surface of the micro mirrors.

9. A moiré magnification device according to claim 6, wherein the image elements are embossed as diffractive gratings, holographic structures or moth-eye structures in the surface of the concave micro mirrors.

10. A moiré magnification device according to claim 1, wherein the micro image array comprises a first set of micro images and a second set of micro images, the first set of micro images and the second set of micro images being aperiodic in accordance with the aperiodicity of the micro focusing element array such that the moiré magnifications of the first set of micro images appear to be at a different plane to the moiré magnifications of the second set of micro images.

11. A method of producing a moiré device for authenticating security articles, the method comprising the steps of:
forming an aperiodic array of micro focusing elements;
forming an aperiodic array of micro images positioned relative to corresponding micro focusing elements within the aperiodic array of micro focusing elements; such that,
the array of micro focusing elements generate moiré magnifications when viewing the device is viewed from predetermined angles.

12. A method according to claim 11, further comprising the steps of:
providing a substrate, and
embossing the micro focusing elements on one side of the substrate while simultaneously embossing the micro images on the other side of the substrate.

13. A method according to claim 11, wherein the micro focusing elements and the micro images are embossed into a radiation curable material applied to the substrate and subsequently or simultaneously cured.

14. A method according to claim 13, wherein the array of micro images comprises individual image elements embossed into respective micro focusing elements within the array of micro focusing elements.

15. A method according to claim 13, wherein the individual image elements and the micro focusing elements are simultaneously embossed on the one side of the substrate.

16. A security article incorporating a moiré magnification device according to claim 1.

17. A security article according to claim 16, wherein the micro focusing elements have different sizes and focal lengths.

18. A security article according to claim 16, wherein the security article is a banknote.
